(19) United States
(12) Patent Application Publication
(10) Pub. No.: US 2002/0177986 A1
(43) Pub. Date: Nov. 28, 2002

(54) Simulation method and system using component-phase transformations

(76) Inventors: George P. Moeckel, Duncanville, TX (US); Denis P. Schmitt, Katy, TX (US)

Correspondence Address: ExxonMobil Upstream Research Company, P.O. Box 2189, Houston, TX, 77252-2189, US

(21) Appl. No.: 10/047,161

(22) Filed: Jan. 14, 2002

Related U.S. Application Data
(60) Provisional application No. 60/262,319, filed on Jan. 17, 2001.

(51) Int. Cl. G06G 7/48

(52) U.S. Cl. 703/9

(57) ABSTRACT

A simulator is disclosed that employs a novel matrix in a domain transform process so as to implement a coherent simulation that accounts for diverse phenomena that are formulated in terms of different sets of variables. The novel matrix also has additional applications that include evaluation of a source term for continuity equations. In one embodiment, the simulator includes a fluid flow simulation block that evaluates phase continuity equations in a first domain and evaluates phase equilibrium and flash equations in a second domain. In performing an inverse transform from second domain components to first domain components, a component distribution matrix is employed so that matrix properties representing an underlying principle of mass conservation are preserved in the inverse transform. Other matrices that relate a component molar density vector to a phase molar density vector are also described.

### CROSS-REFERENCE TO RELATED APPLICATIONS

This application claims priority benefit to U.S. provisional application number 60/262,319 filed Jan. 17, 2001.

### FIELD OF THE INVENTION

The present invention generally relates to systems and methods for performing simulations. More specifically, the invention relates to systems and methods that perform calculations in multiple domains and use domain transformations to move between the domains. The transformations preserves a basic, underlying principle common to all domains, which is useful in simulating one or more properties of a multi-component fluid contained in a physical system.

### BACKGROUND OF THE INVENTION

Numerical simulation is widely used in industrial fields as a method of simulating a physical system by using a computer. In most cases, there is a desire to model the transport processes occurring in the physical system. What is being transported is typically mass, energy, momentum, or some combination thereof. By using numerical simulations, it is possible to model and observe a physical phenomenon or several coupled phenomena.

Basin simulation is of great interest because it provides quantitative prediction of the timing, volumetrics, quality and distribution of oil and gas in a petroleum system as well as pressure. From an exploration point of view, it provides a means to quantify the risk of drilling opportunities by prediction of the most probable volumes of petroleum accumulated, quality of petroleum, timing (petroleum generation relative to trap formation), targets of commercial petroleum accumulation based on sensitivity analysis of poorly constrained basin parameters and pressure. All simulations are constrained by interpreted seismic data, chrono-stratigraphy, geochemical and well log data.

An integrated basin simulator is complex. It is able to perform numerical modeling through geologic times of coupled basin processes such as sedimentary deposition, burial and compaction, structural evolution, uplift and erosion, thermal evolution, petroleum generation and expulsion, fluid migration, petroleum accumulation and pressure estimation at the present day. One key feature is the presence of organic chemical reactions modeling the solid kerogen decomposition coupled with temperature evolution that generates solid and flowing petroleum products. These petroleum products may also undergo further cracking reactions as a function of temperature during fluid migration. Accordingly, the organic chemical reactions are coupled with mass transfer and fluid flow process. Large scale rock deformation associated with burial is also coupled with fluid flow processes. The pore fluid pressure may have a large effect on rock deformation and porosity and, at any instant, the molar volumes of the flowing fluid phases stored in a rock are strongly influenced by porosity. Because these coupled processes are so complex, basin simulations can only be done using computers. The objective of basin simulation is to understand the complex interaction of these processes occurring in a basin to help minimize the risk of petroleum exploration and drilling.

Modeling of these complex processes involves use of partial differential equations. As a means for numerically solving such equations, there are known the finite element method, the finite difference method, the finite volume method and the like. Regardless of which method is used, the physical system (i.e., the basin or the reservoir) to be modeled is divided into cells (a set of which is called a grid or mesh), and the state variables that vary in space throughout the model are represented by sets of values for each cell. In order to analyze the evolution of the basin that changes in time, it is necessary to calculate physical quantities at discrete intervals of time called timesteps, irrespective of the continuously changing conditions as a function of time. Basin simulation proceeds in a sequence of timesteps. Although coupled, some of the processes can be evaluated sequentially within a global timestep. This results in lagged variables for some processes. For example, thermal calculation may be performed prior to the resolution of rock motion coupled with fluid flow that can then be performed under isothermal conditions.

Simulations based on immiscible fluid flow, for which there is no component exchange among the fluid phases (aqueous, liquid petroleum (oil) and vapor petroleum (gas)) are often not as representative of multi-component, multi-phase fluid flow as compositional simulations. Compositional simulations based on compositional fluid flow are well known to reservoir simulation as a process of inferring the behavior of a real reservoir from the performance of a model of that reservoir. The compositional model describes reservoir hydrocarbon as a multiple-component mixture. Gas and oil phase properties and equilibrium are calculated from pressure and composition dependent correlations or, more typically, from suitable equations of state (EOS). Several EOSs have been developed and are in use today, including for example the Redlich-Kwong EOS and the Peng-Robinson EOS.

Compositional reservoir simulators using an EOS to describe the phase behavior of multi-component fluid mixtures are expensive to use because of the large number of iterative phase equilibrium calculations and large computer storage space required. The number of equations having to be solved in EOS calculations is proportional to the number of components in the fluid. To limit the computational time of compositional reservoir simulation, a common practice is to pseudoize the fluid description. In the pseudoization, the pure compounds are grouped into a number of component groups, termed pseudocomponents. The pseudocomponents are treated as if they were pure components in subsequent reservoir simulations.

Basin processes are relatively slow so that the assumptions and constraints of phase equilibrium based on EOS equations, as mentioned above, equally apply to basin simulation. Miscible compositional fluid flow is important to basin simulation. The exchange of the components between the phases, which depends on pressure, temperature and composition, can affect numerous phenomena that cannot be observed with an immiscible flow model. When light (gas) components are present in the liquid petroleum phase, the viscosity and the density of the phase are decreased. Consequently, the liquid petroleum phase migrates faster than in the immiscible situation. On the other hand, the presence of oil components in the vapor petroleum phase will tend to slow down the migration of the phase. Changes in pressure conditions during migration can lead to the exsolution of the light components that migrated within the liquid petroleum phase. Overall, the timing of migration, the number of phases during migration, and the distribution and composition of the accumulations may be affected. Immiscibility of the aqueous phase may also not be a reasonable assumption. Light petroleum components, in particular methane, are soluble in water or brine with decreasing solubility as salinity increases. Modeling, detecting and predicting the presence of low saturation gas and/or ‘fizz’ (gaseous) water are important exploration problems in determining commercial gas accumulations.

In the porous medium, component mass balance and momentum balance based on generalized Darcy's law are used for fluid flow process. Persons skilled in the art of multiphase fluid flow recognize that the generalized Darcy's law requires knowledge of the number and properties of the flowing phases, such as intrinsic density, viscosity, capillary pressure, mole fraction and composition in terms of the flowing components. The compositional property is a key parameter, which is typically expressed in the form of a non-square matrix. With immiscible fluid flow, phases and components are the same, and their properties can be evaluated using equations based on observations. With compositional miscible fluid flow, however, it is desirable to take into account the exchange of components among the phases based on phase equilibrium and flash calculations. Phase equilibrium and flash calculations can also provide information about the physical properties of the phases which are required to perform fluid flow calculations.

Several kerogen decomposition models have been proposed that use generic-generated flowing petroleum products, such as gas and oil, or dry gas, wet gas and oil, or dry gas, wet gas, light oil and heavy oil. These models depend on the region of interest, the type of kerogen present, the availability of calibrated data, and the method of characterization. The flowing components can undergo secondary cracking as a function of temperature. Products generated by the kerogen decomposition and their secondary cracking provide the source terms for the fluid flow. These flowing components can be defined in terms of EOS components or pseudocomponents by mappings that assure component mass balance. The mapping is based on detailed analysis of petroleum products known to be generated by similar kerogens and must be compatible with some basic parameters used in the kerogen model. The number of EOS components is typically greater than or equal to the number of flowing kinetic components. For example, the wet gas can be defined as a composition (based on mole fraction) of methane, ethane, propane, butane and pentane. With this set of conditions, compositional fluid flow process will involve transformations from one domain of components to a second domain of components, and reciprocally. Such direct and inverse transformations have to be performed in such a way that mass balance is preserved overall and that the non-square composition matrix of the phases in terms of the flowing components can be defined with its inherent properties. The increased computational cost of computing transformations to move between the domains may at first seem prohibitive, but the transformational cost may be more than offset by computational savings that result from reduced domain size.

A need exists for a method of performing miscible compositional fluid flow with a set of flowing components different from, but related to, a set of EOS components used for evaluating the exchange of the components among the phases. The two sets of components are different in terms of number and are assumed to be linked by a mapping, constant in time and space, that preserves mass. The phases are assumed to be identical in both domains. The heart of the problem is to evaluate the composition of the phases obtained in the EOS domain in terms of the flowing components with all its inherent properties.

It is noted, however, that the transformations linking the various domains are a potential source of numerical error and instability. It is therefore desirable to provide a robust transformation method that enables one to build a practical, coherent simulation of a complex system.

### SUMMARY OF THE INVENTION

This invention relates to a method for evaluating the composition of the flowing phases in terms of a set of flowing components that are different from, but related to, a set of EOS components or pseudocomponents used to obtain the number and properties of the flowing phases as a function of pressure and temperature based on phase equilibrium and flash calculations. The flowing components, which can be reactive in their own domain, are related to the EOS components and/or pseudocomponents through a mapping, based for example on mole fraction, that preserves mass and is constant in time and space. The number of flowing components is less than or equal to the number of EOS components. One or several flowing components can be an EOS component and an EOS component can be present in more than one flowing component. The method is based on the definition of a non-square matrix that expresses the distribution of the components among the phases and can be evaluated in both domains. Other matrices can also be defined that can be used for other applications.

While much of the ensuing description is directed toward oil field basin simulation, it is understood that the disclosed method will also apply to reservoir simulation.

### DESCRIPTION OF THE DRAWINGS

A better understanding of the present invention can be obtained when the following detailed description of the preferred embodiment is considered in conjuction with the following drawings, in which:

FIG. 1 is a block diagram of a preferred fluid flow simulator embodiment.

FIG. 2 is a diagram of a computer that may be configured to effectuate simulations according to the present invention.

### DETAILED DESCRIPTION

An improved method is herein described for estimating one or more properties of a multi-component fluid contained in a physical system containing two or more phases. In the first step, the physical system is equated in at least one dimension to a multiplicity of cells. For each cell, the multi-component fluid is characterized using a property of a first set of components and the characterization is represented by a first vector. For each cell, the first vector is transformed to a second vector using a first matrix (first transformation matrix), the first matrix being indicative of the distribution of the first set of components and the second vector being representative of a property of a second set of components greater in number than the first set of components. The second vectors are then used to determine the number and properties of the phases present in each cell. Elements of a second matrix are then determined that expresses distribution of the second vectors among the phases. The elements of a third matrix are then determined that expresses distribution of the first vectors among the phases. A fourth matrix is then determined that expresses the composition of the phases in terms of the first vectors. The fourth matrix is then used to perform fluid flow calculations to estimate one or more properties of the multi-component fluid. In practicing the invention, certain operations are performed in one domain and other operations are performed in a second domain. The first domain has a set of components that characterize the multi-component fluid and the second domain has a second set of components, greater in number than the first set, that characterize the multi-component fluid. It is assumed that the phases in both domains are the same.

The following description makes use of several mathematical symbols, many of which are defined as they occur in this description. Additionally, for purpose of completeness, a list of symbols containing definitions of symbols used herein is presented in an Appendix which is located at the end of this detailed description. In order to differentiate the variables defined in both domains, the superscript^{(f)} is used to indicate the flowing components domain while the superscript^{(e)} is used for the EOS components domain. When no superscript is present, it is implied that the relations can be defined in either domain. An indicial notation is maintained to differentiate the variables related to components or phases. Lower-case, Greek-letter subscripts indicate a component while upper-case, Latin-letter subscripts indicate a phase. Einstein's convention (i.e., sum over repeated indices) is not used. Summation over indices will be indicated by the symbol Σ with the lower and upper bounds given at the bottom and top of the symbol, respectively. Vectors are indicated by underlined letters, while matrices are indicated by double underlined letters. The usual matrix product is indicated by the symbol “·”.

Definitions

Before proceeding with the detailed description of the invention, a definition of the phase mole fractions of components of the multi-component fluid (or distribution of the components among the phases) is first presented. Consider a fluid mixture made of N_{c} fluid components distributed over N_{P} fluid phases that corresponds to a total mixture molar density m, which is expressed as the total number of moles per unit basin/reservoir volume. It is understood that the number of components is greater than or equal to the number of phases, that is, N_{c}≧N_{P}. Let m_{α} be the mixture molar density of component α and η_{J} be the mixture molar density of phase J. By definition of the mass balance, the total mixture molar density is equal to the sum over all the molar densities of the components and to the sum over all the molar densities of the phases:

$$m = {\sum }_{α = 1}^{{N}_{c}} {m}_{α} = {\sum }_{J = 1}^{{N}_{P}} {η}_{J} \qquad ( 1 )$$

It is noted that equation (1) can be written with any unit. The mixture molar density (m_{α}) of component α can be defined as the sum over the phases of the mixture molar densities of component α in phase J, denoted d_{αJ}, that corresponds to the total number of moles of component α in phase J per basin/reservoir volume. Similarly, the mixture molar density (η_{J}) of phase J can be defined as the sum over the components of the mixture molar densities of component α in phase J (d_{αJ}). The relations are then:

$${m}_{α} = {\sum }_{J = 1}^{{N}_{P}} {d}_{α J} , ∀ α ∈ [ 1 , {N}_{c} ] ; and {η}_{J} = {\sum }_{α = 1}^{{N}_{c}} {d}_{α J} , ∀ J ∈ [ 1 , {N}_{P} ] \qquad ( 2 )$$

The mole fraction of component α in phase J, noted x_{αJ}, is the ratio of the mixture molar density of components α in phase J (d_{αJ}) to the mixture molar density of phase J (η_{J}). As such, x_{αJ} is a number equal to zero or positive but less than or equal to 1. For any phase J, the sum over the components of the mole fractions x_{αJ} is 1 as derived using equation (2):

$${x}_{α J} = \frac{{d}_{α J}}{{η}_{J}} , 0 \leq {x}_{α J} \leq 1 ; \\ with \\ {\sum }_{α = 1}^{{N}_{c}} {x}_{α J} = \frac{{\sum }_{α = 1}^{{N}_{c}} {d}_{α J}}{{η}_{J}} = \frac{{η}_{J}}{{η}_{J}} = 1 , ∀ J ∈ [ 1 , {N}_{P} ] \qquad ( 3 )$$

The mixture molar density of components α, m_{α}, can then be expressed as a function of the mixture molar density of phase J, η_{J}, using equation (2) as:

$${m}_{α} = {\sum }_{J = 1}^{{N}_{P}} {d}_{α J} = {\sum }_{J = 1}^{{N}_{P}} \frac{{d}_{α J}}{{η}_{J}} {η}_{J} = {\sum }_{J = 1}^{{N}_{P}} {x}_{α J} {η}_{J} , ∀ α ∈ [ 1 , {N}_{c} ] \qquad ( 4 )$$

Such a relation can be expressed in a matrix form. Let m be the N_{c} vector whose elements are the m_{α}, η be the N_{P} vector whose elements are the η_{J}, and x be the non-square N_{c}×N_{P} matrix whose elements are the x_{αJ}. Equation (4) can then be written as:

m=x·η. (5)

The phase (J) mole fraction of the component α, noted y_{Jα}, can be defined as the ratio of the mixture molar density of component α in phase J (d_{αJ}) to the mixture molar density of component α (m_{α}). As such, y_{Jα} is a number equal to zero or positive but less than or equal to 1. For any component α, the sum over the phases of the mole fractions y_{Jα} is equal to 1 as derived using equation (2):

$${y}_{J α} = \frac{{d}_{α J}}{{m}_{α}} , 0 \leq {y}_{J α} \leq 1 ; \\ with \\ {\sum }_{J = 1}^{{N}_{P}} {y}_{J α} = \frac{{\sum }_{J = 1}^{{N}_{P}} {d}_{α J}}{{m}_{α}} = \frac{{m}_{α}}{{m}_{α}} = 1 , ∀ α ∈ [ 1 , {N}_{c} ] . \qquad ( 6 )$$

The mixture molar phase densities η_{J} can then be related to the mixture molar densities of the components m_{α} by a relation dual of that expressed by equation (4) as:

$${η}_{J} = {\sum }_{α = 1}^{{N}_{c}} {d}_{α J} = {\sum }_{α = 1}^{{N}_{c}} \frac{{d}_{α J}}{{m}_{α}} {m}_{α} = {\sum }_{α = 1}^{{N}_{c}} {y}_{J α} {m}_{α} , ∀ J ∈ [ 1 , {N}_{P} ] \qquad ( 7 )$$

which can be written in a matrix form similar to equation (5) as:

η=y·m (8)

where y is the N_{P}×N_{c} matrix whose elements are the mole fractions y_{Jα}.

A relation between the mole fractions x_{αJ} and y_{Jα} can be defined using their definition given by equations (3) and (6), respectively, as, for any component α and any phase J:

$$\begin{matrix}{x}_{α J} = \frac{{d}_{α J}}{{η}_{J}} = \frac{{d}_{α J}}{{m}_{α}} \frac{{m}_{α}}{{η}_{J}} = {y}_{J α} \frac{{m}_{α}}{{η}_{J}} , ∀ α ∈ [ 1 , {N}_{c} ] and ∀ J ∈ [ 1 , {N}_{P} ] & ( 9 ) \\ {y}_{J α} = \frac{{d}_{α J}}{{m}_{α}} = \frac{{d}_{α J}}{{η}_{J}} \frac{{η}_{J}}{{m}_{α}} = {x}_{α J} \frac{{η}_{J}}{{m}_{α}} , ∀ α ∈ [ 1 , {N}_{c} ] and ∀ J ∈ [ 1 , {N}_{P} ] & ( 10 )\end{matrix}$$

Such relations allow, with the knowledge of the elements of the m vector and the η vector, to compute the elements of the y matrix from those of the x matrix and reciprocally. These definitions apply to any field where the concept of moles can be defined. Persons skilled in the art would recognize that the elements of the vectors m and η can be defined in many different ways as long as their elements verify a relation similar to equation (1). This would correspond to normalization of the elements of each vector by a given number. These relations are independent from the calculations that provide the x matrix or the y matrix.

Persons skilled in the art of phase equilibrium and flash and petroleum reservoir science are familiar with equations (1) to (5). Vector m is usually referred to as the feed whose elements m_{α}, are defined as the global mole fractions of the components, that is, the total number of moles of component α divided by the total number of moles in the mixture. The vector η is referred to as the phase mole fraction, its elements being defined as the global mole fractions of the phase, i.e., the total number of moles of phase J divided by the total number of moles in the mixture. For a given pressure, temperature and a set of components with their properties related to a given equation of state (EOS), phase equilibrium computations, based on the equalities of the fugacties of the components in the phases, provide the number of phases and their properties among which are the mixture phase molar density (equivalent to the phase volume fraction) η_{J} and the elements x_{αJ} of the non-square N_{c}×N_{P} matrix (see the recent book by A. Firoozabadi, “Thermodynamics of Hydrocarbon Reservoirs”, McGraw-Hill, 1999). Also provided are derivatives with respect to the mixture molar density of the EOS components and pressure. Such derivatives are required to perform multiphase compositional fluid flow based on Darcy's law. The calculations are typically performed with only petroleum components. Interaction of the water component with the petroleum phase and of the petroleum components with the aqueous/brine phase can also be considered (see the article of Li Y-K and Nghiem L. X., 1986, “Phase Equilibria of Oil, Gas and Water/brine Mixtures from a Cubic Equation of State and Henry's Law”, The Canadian Journal of Chemical Engineering, Vol. 64, p. 486-495).

The inventors have discovered that the non-square y matrix or its elements y_{Jα} can be useful in many different applications. The non-square N_{P}×N_{c} matrix y whose elements are defined by equation (6), is not the generalized inverse of the non-square matrix x whose elements are defined by equation (3). A form of the pseudo-inverse of the matrix x is:

y*=(x^{T}·x)⁻¹·x^{T} (11)

where the superscript ^{T} indicates the matrix transpose and the superscript ⁻¹ indicates the inverse. With such a definition, assuming that the N_{P}×N_{P} square matrix (x^{T}·x) is invertible, the N_{P}×N_{P} matrix product C*=y*·x is equal to the identity matrix, and the non-square matrix N_{P}×N_{c} y* verifies a relation of the form of equation (8), that is, y*·m=η. However, there is no guarantee that the elements y_{Jα}* verify the properties outlined in equation (6) as required by the physics of the particular application of the invention and of the very definition of the matrix. Therefore, although mathematically correct, for most applications use of the matrix y* for is not desirable.

The non-square matrix y defined by equations (6) and (8) is mathematically sound and can be used to build useful matrices. Consider, for example, the N_{P}×N_{P} square matrix C defined as the product of the y matrix times the x matrix, i.e.,

$$\underline{\underline{C}} = \underline{\underline{y}} \underline{\underline{x}} ⇔ {C}_{JK} = {\sum }_{α = 1}^{{N}_{c}} {y}_{J α} {x}_{α K } . \qquad ( 12 )$$

The matrix C is not equal to the N_{P}×N_{P} identity matrix but, by construction, η is one of its eigenvectors, associated with the eigenvalue 1. Indeed, equations (5) and (8) yield:

η=y·m=y·x·η⇄η=C·η. (13)

Although not equal to the identity matrix, the N_{P}×N_{P} C mattrix exhibit useful properties. Using equations (12), (6) and (3) the sum of the elements of any of the column vectors of the C matrix is proven to be equal to 1, considering any phase K:

$$\begin{matrix} ∀ K ∈ [ 1 , {N}_{P} ] , \\ {\sum }_{J = 1}^{{N}_{P}} {C}_{JK} = {\sum }_{J = 1}^{{N}_{P}} ( {\sum }_{α = 1}^{{N}_{c}} {y}_{J α} {x}_{α K} ) = {\sum }_{α = 1}^{{N}_{c}} ( {\sum }_{J = 1}^{{N}_{P}} {y}_{J α} ) {x}_{α K} = {\sum }_{α = 1}^{{N}_{c}} {x}_{α K} = 1.\end{matrix} \qquad ( 14 )$$

Because of the condition that the number of phases is always equal to or less than the number of components (i.e., N_{P}≦N_{c}), the square matrix C is non-singular and can thus be inverted. It can then be shown that the sum of the elements of any of the column vector of the N_{P}×N_{P} C⁻¹ matrix, inverse of the C matrix, is equal to 1. Let δ_{L K} be the Kronecker symbol, that is,

$${δ}_{LK} = \{ \begin{matrix}1 , for L = K \\ 0 , for L \neq K\end{matrix} , and {\underline{\underline{I}}}^{{N}_{P}}$$

be the N_{P}×N_{P} identity matrix. By definition of an inverse matrix:

$${C}_{\underline{\_}} \cdot {{C}_{\underline{\_}}}^{- 1} = {{I}_{\underline{\_}}}^{{N}_{P}} ⇔ {\sum }_{J = 1}^{{N}_{P}} {C}_{L J} {C}_{J K}^{- 1} = {δ}_{L K} .$$

Equation (14) then yields for any phase K:

$${\sum }_{L = 1}^{{N}_{P}} {\sum }_{J = 1}^{{N}_{P}} {C}_{L J} {C}_{J K}^{- 1} = {\sum }_{L = 1}^{{N}_{P}} {δ}_{L K} = 1 = {\sum }_{J = 1}^{{N}_{P}} ( {\sum }_{L = 1}^{{N}_{P}} {C}_{L J} ) {C}_{J K}^{- 1} = {\sum }_{J = 1}^{{N}_{P}} {C}_{J K}^{- 1} \qquad ( 15 )$$

which is the desired result. Persons skilled in the art of numerical simulation will find applications for the C and C⁻¹ square N_{P}×N_{P} matrices, especially in problems related to inversion.

The N_{c}×N_{c} square matrix c is defined as the product of the x matrix times the y matrix, that is:

$${c}_{\underline{\_}} = {x}_{\underline{\_}} \cdot {y}_{\underline{\_}} , ⇔ {c}_{αβ} = {\sum }_{J = 1}^{{N}_{P}} {x}_{α J} {y}_{J β} . \qquad ( 16 )$$

Such a matrix is of lesser interest than its dual counterparts C because for most basin/reservoir simulations the number of components will be greater than the number of phases (that is, N_{c}>N_{P}). Such a condition implies that the matrix c will be singular or near singular (i.e., the ratio of the smallest eigenvalue to the largest eigenvalue will be less than the precision required for the calculations). Therefore, the matrix cannot be inverted and the properties relative to its inverse (as described by equation (15) for the inverse of the C matrix) do not apply in the components domain. However, by construction, the vector m is an eigenvector of the c matrix associated with the eigenvalue one (as seen from equations (5) and (8)):

m=x·η=x·y·m⇄m=c·m. (17)

Second, the sum of the elements of any of the column vectors of the c matrix is equal to 1:

$$∀ β ∈ [ 1 , {N}_{c} ] , {\sum }_{α = 1}^{{N}_{c}} {c}_{αβ} = {\sum }_{α = 1}^{{N}_{c}} ( {\sum }_{J = 1}^{{N}_{P}} {x}_{α J} {y}_{J β} ) = {\sum }_{J = 1}^{{N}_{P}} ( {\sum }_{α = 1}^{{N}_{c}} {x}_{α J} ) {y}_{J β} = {\sum }_{J = 1}^{{N}_{P}} {y}_{J β} = 1. \qquad ( 18 )$$

Compositional Miscible Fluid Flow

In simulations of miscible compositional fluid flow using generalized Darcy's law, the principal equations to be solved involve the balance of component mass and the balance of momentum. In the following, the equations are written in terms of the flowing components. For a given flowing component α^{(f)}, the mass balance is:

$$\frac{\partial {m}_{{α}^{( f )}}^{( f )}}{\partial t} + div [ {m}_{{α}^{( f )}}^{( f )} {\underline{v}}^{( {a}^{( f )} )} ] = {q}_{{α}^{( f )}}^{( f )} \qquad ( 19 )$$

where t is the time and div indicates the divergence operator taken with respect to the Eulerian coordinates. v^{(α}^{^{(f)}}⁾ represents the vector of the particle velocity of the fluid component α^{(f)} and

$${q}_{{α}^{( f )}}^{( f )}$$

represents the source molar density rate relative to the same component. For basin simulation, the source term comes from the kinetic model (decomposition of the kerogen in the source cells and possible secondary cracking in every cell), while for reservoir simulation, the source (or sink) term comes from the presence of injection or producing wells. The particle fluid velocity of the fluid component α^{(f)} is related to the particle velocity V^{(J)} of the fluid phase J as follows:

$${m}_{{α}^{( f )}}^{( f )} {\underline{v}}^{( {a}^{( f )} )} = {\sum }_{J = 1}^{{N}_{P}} {x}_{{α}^{{( f )}_{J}}}^{( f )} {η}_{J} {\underline{V}}^{( J )} . \qquad ( 20 )$$

The momentum balance for the fluid phase J results from Darcy's law as:

$${\underline{V}}^{( J )} - {\underline{V}}^{( R )} = - \frac{ {K}_{\underline{\_}} {k}_{rJ}}{ϕ {S}_{J} {μ}_{J}} \cdot \underline{grad} ( P - {P}_{c J} - {ρ}_{J} g z ) \qquad ( 21 )$$

where V^{(R)} is the solid particle velocity which is zero in reservoir simulation; grad indicates the gradient operation with respect to the Eulerian coordinates; K is the absolute permeability tensor; φ is the porosity of the material; k_{rJ} is the relative permeability; S_{J} is the saturation (that is, the volume fraction); μ_{J} is the viscosity of fluid phase J; P is the reference pressure (generally that of the aqueous fluid phase) while P_{cJ} is the capillary pressure; ρ_{J} is the intrinsic mass density of the fluid phase J; g is the acceleration of gravity; and z is the depth. Introducing equation (21) into equation (19) using equation (20) and the relation between the mixture phase molar density of the phase J (η_{J}) and the intrinsic phase molar density of phase J (ξ_{J}), that is:

η_{J}=φS_{J}ξ_{J} (22)

leads to the component balance equations to be solved for each mixture molar density

$${m}_{{α}^{( f )}}^{( f )}$$

of the flowing component α^{(f)}:

$$\frac{\partial {m}_{{α}^{( f )}}^{( f )}}{\partial t} - div [ {\sum }_{J = 1}^{{N}_{P}} {x}_{{α}^{{( f )}_{J}}}^{( f )} {ξ}_{J} {K}_{\underline{\_}} \frac{{k}_{rJ}}{{μ}_{J}} \cdot \underline{grad} ( P - {P}_{c J} - {ρ}_{J} g z ) ] + div [ {m}_{{α}^{( f )}}^{( f )} {\underline{V}}^{( R )} ] = {q}_{{α}^{( f )}}^{( f )} . \qquad ( 23 )$$

The resulting system of equations is highly non-linear and requires knowledge of the number and the properties of the phases as a function of the mixture molar densities

$${m}_{{α}^{( f )}}^{( f )}$$

of the chosen flowing components α^{(f)} the pressure P and the temperature T which is assumed constant during the time step. The resolution also requires additional equations that act as constraints relative to the saturation in reservoir simulation and to the porosity in basin simulation. Models for the variation of the relative permeabilities and capillary pressures also need to be defined. The resolution can be performed either explicitly (IMPES type) or fully implicit (see, for example, the book by Aziz K. and Settari, A., 1979, Petroleum Reservoir Simulation, Applied Science Publishers). Either way, it involves an iterative method that requires the evaluation of the so-called Jacobian matrix based on the derivatives of the phase properties with respect to the principal unknowns which in basin simulation are the mixture molar densities

$${m}_{{α}^{( f )}}^{( f )}$$

of the flowing components, the pressure P, and the porosity φ. Equation (23) illustrates that once a domain ^{(f)} is chosen for the flowing components, the system can be solved only if the composition of the phases with respect to these flowing components represented by the elements

$${x}_{{α}^{( f )} J}^{( f )}$$

of the non-square matrix x^{(f)} are known, as well as the phase properties.

In conventional reservoir simulation, the flowing components are chosen to be in the EOS domain ^{(e)} which is also the domain in which the number and the properties of the flowing phases are evaluated. The present invention allows use of another domain ^{(f)} in which the components are related to the EOS components by a transformation, constant in space and time, that preserves mass. In basin simulation, a natural definition of the flowing components is the flowing components generated by the decomposition of the kerogen in the source rock, which are also subject to secondary cracking as a function of temperature. A different domain could be chosen for when performing reservoir simulation. Using two domains in performing a simulation decreases the size of the system to be solved (the number of flowing components being less than the number of EOS components).

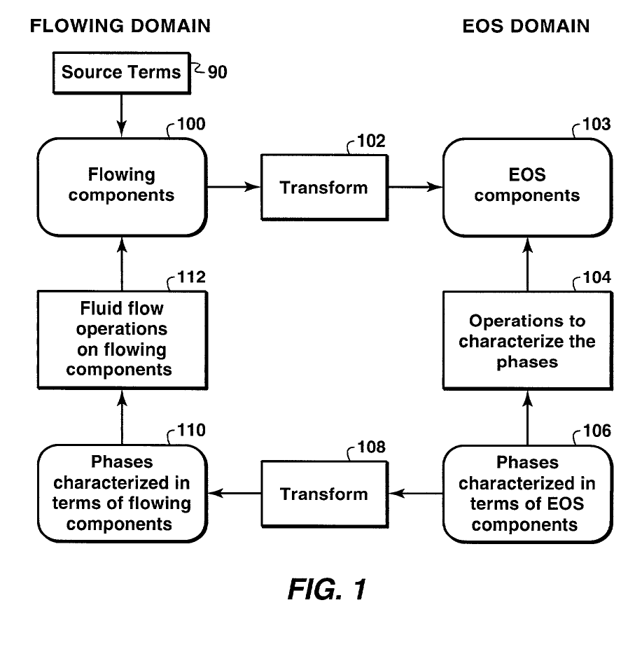

FIG. 1 schematically illustrates the principal steps in carrying out an oil basin simulation in accordance with the practice of the present invention. A general overview is first described, followed by a more detailed analysis.

One cycle of the loop depicted in FIG. 1 represents a cycle of a single time step. The choice of the kerogen decomposition model including secondary cracking defines the source terms (represented by block 90) within each cell of the domain at each time step which play the role of initial conditions to the fluid flow simulation at each time step. The number of flowing components in each cell is then determined by solving the fluid flow equations.

As indicated in block 100, the definition of the source terms 90 implies a choice of the nature and number of the flowing components as represented by the mixture molar densities casted in the vector m^{(f)}. It is also implicitly assumes that these flowing components have been defined in terms of a certain number of EOS components. In block 102, the flowing components are transformed into a set of predefined EOS components as represented by the mixture molar densities vector m^{(e)} in block 103. This transformation is by carried out by a transformation matrix T^{(ef)} of the type described by equation (24) below. In block 104, an EOS, such as Peng-Robinson model, is applied to each EOS component to determine the phase distribution equilibrium of each EOS component in each of the cells. This determines the number of phases, N_{P}; the mixture phase molar densities η^{(e)}; and the EOS phase composition matrix x^{(e)}. Block 106 represents the resulting EOS component phases that results from the calculations of block 104. These phases are preferably expressed in the form of EOS component fraction matrix y^{(e)} (equation (10)).

To reduce simulation complexity, the remaining simulation operations are performed on flowing components. To restate the EOS component fraction y in terms of the flowing components, an inverse transform (block 108) is applied to the y^{(e)} matrix of block 106 to determine the phases in terms of flowing components (block 110) as represented by the flowing component fraction matrix y^{(f)} of block 108. Assuming that the phases are the same in both domains, the inverse transform takes the form of equations (32) as given below.

In block 112, operations are performed on the flowing component phases of block 110 to determine a new distribution of flowing components. The operations in block 112 preferably include determining partial derivatives of key variables with respect to unknowns and a solution to fluid flow equations, using contributions from source rocks and molecular cracking, phase extraction, and other suitable operations.

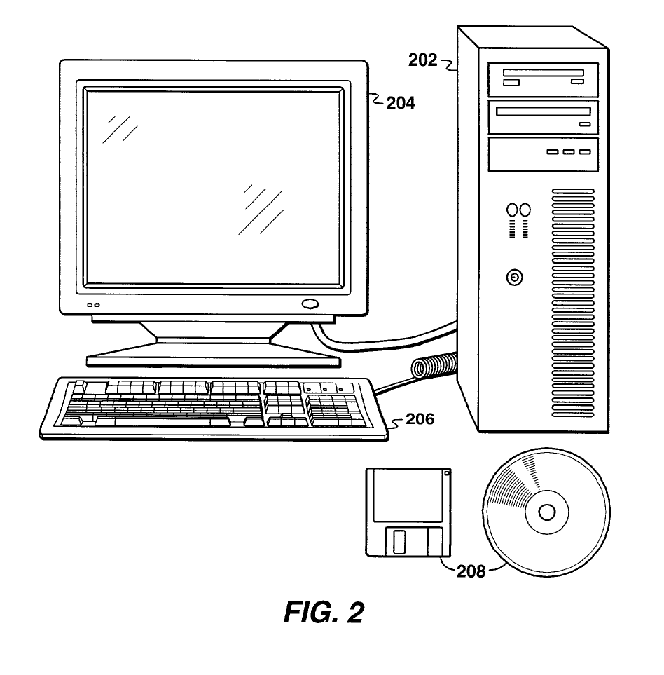

Referring now to FIG. 2, the simulation steps outlined in FIG. 1 are preferably implemented as a software program executed by a computer 202. Simulation results may be displayed on a monitor 204, and interaction with a user is accomplished via monitor 204 and an user input device 206. The software may be stored on computer readable information storage media 208, or accessed over a network or other suitable information transmission medium (not shown). One of skill in the art will recognize that computer 202 includes a processor and a memory, and that the processor may retrieve the software from memory. Execution of the software configures the processor to operate on digital signals stored in memory and manipulate those signals so as to carry out the simulation in the manner specified by the software.

Detailed Analysis

The principal steps in carrying out the present invention as illustrated in the flow chart of FIG. 1 are now presented in detail.

At block 100, it is assumed that a choice has been made for a set of N_{c}^{(f)} flowing components different from the number of EOS components. Implicitly, the pressure and temperature are considered as known and the choice of equation of state has also being made. The flowing components have also been defined in terms of N_{c}^{(e)} EOS components, for example, based on mole fractions. The definition is assumed to be constant in space and time. It is understood that the number N_{c}^{(e)} of EOS components is greater than or equal to the number N_{c}^{(f)} of flowing components. It is also understood that an EOS component can be present in several of the flowing components and/or that a component can be both an EOS component and a flowing component. The transformation from the flowing components domain to the EOS domain is defined through a non-square N_{c}^{(e)}×N_{c}^{(f)} matrix (T^{(ef)} with elements of the form

$${T}_{{α}^{( e )} {α}^{( f )}}^{( ef )} )$$

that relates the mixture EOS component molar densities

$${m}_{{α}^{( e )}}^{( e )} ,$$

casted in the N_{c}^{(e)} vector m^{(e)}, to the mixture molar densities

$${m}_{{α}^{( f )}}^{( f )}$$

of the flowing components, casted in the N_{c}^{(f)} vector m^{(f)}, as:

$${\underline{m}}^{( e )} = {\underline{\underline{T}}}^{( ef )} \cdot {\underline{m}}^{( f )} ⇔ {m}_{{α}^{( e )}}^{( e )} = {\sum }_{{α}^{( f )} = {1}^{( f )}}^{{N}_{c}^{( f )}} {T}_{{α}^{( e )} {α}^{( f )}}^{( ef )} {m}_{{α}^{( f )}}^{( f )} . \qquad ( 24 )$$

Such an operation is performed in block 102 with the result casted in block 103.

The elements

$${T}_{{α}^{( e )} {α}^{( f )}}^{( ef )}$$

are mole fractions so that they vary between 0 and 1, bounds included, and expressed as:

$$0 \leq {T}_{{α}^{( e )} {α}^{( f )}}^{( ef )} \leq 1. \qquad ( 25 )$$

The conservation of mass in both domain can be expressed as the equality of the sum over the component molar densities in both domains, expressed as.:

$${\sum }_{{α}^{( e )} = {1}^{( e )}}^{{N}_{c}^{( e )}} {m}_{{α}^{( e )}}^{( e )} = {\sum }_{{α}^{( f )} = {1}^{( f )}}^{{N}_{c}^{( f )}} {m}_{{α}^{( f )}}^{( f )} \qquad ( 26 )$$

that requires for the sum over the elements of any of the columns of the T^{(ef)} matrix to be equal to 1:

$${\sum }_{{α}^{( e )} = {1}^{( e )}}^{{N}_{c}^{( e )}} {T}_{{α}^{( e )} {α}^{( f )}}^{( ef )} = 1. \qquad ( 27 )$$

The transformation matrix T^{(ef)} is assumed constant in time and space.

At block 104, phase equilibrium calculations are performed with the EOS components for the given pressure and temperature known in block 100. These calculations provide the number (N_{P}) of the phases as well as some of their properties (intrinsic and mixture) among which are the mixture phase molar densities η_{J}^{(e)} that can be represented in a N_{P} vector η^{(e)} and the composition of the phases represented by the matrix x^{(e)} whose elements

$${x}_{{α}^{( e )} J}^{( e )}$$

verify the relations given in equation (3). The component and phase mixture molar density vectors η^{(e)} and m^{(e)} are related through equation (5).

At block 106, in the EOS domain, the elements

$${y}_{J {α}^{( e )}}^{( e )}$$

of the non-square N_{P}×N_{c}^{(e)} y^{(e)} matrix are calculated using equation (10), i.e.,

$${y}_{J {α}^{( e )}}^{( e )} = {x}_{{α}^{( e )} J}^{( e )} {η}_{J}^{( e )} / {m}_{{α}^{( e )}}^{( e )} .$$

By construction, these elements verify the properties given in equation (6), i.e,

$$\begin{matrix}0 \leq {y}_{J {α}^{( e )}}^{( e )} \leq 1 , ∀ {α}^{( e )} ∈ [ 1 , {N}_{c}^{( e )} ] and ∀ J ∈ [ 1 , {N}_{P} ] and & ( 28 ) \\ {\sum }_{J = 1}^{{N}_{P}} {y}_{J {α}^{( e )}}^{( e )} = 1 , ∀ J ∈ [ 1 , {N}_{P} ] . & ( 29 )\end{matrix}$$

The mixture phase and EOS component molar densities are then related by an equation of the type of equation (8), expressed as:

η^{(e)}=y^{(e)}·m^{(e)}. (30)

The assumption of equality of the phases applies to the mixture phase molar densities η^{(e)} and η^{(f)}. Using the transformation between the component molar densities (equation (24)) and the relation (30) written in both domains, a relation is found between the non-square N_{P}×N_{c}^{(e)} matrix y^{(e)} and the non-square N_{P}×N_{c}^{(f)} matrix y^{(f)}:

η^{(e)}=η^{(f)}⇄y^{(e)}·m^{(e)}=y^{(f)}·m^{(f)}⇄y^{(e)}·T^{(ef)}·m^{(f)}=y^{(f)}·m^{(f)} (31)

By identification of the coefficients of the elements

$${m}_{{α}^{( f )}}^{( f )}$$

on both sides of the above equation, a particular solution is obtained as:

$${\underline{\underline{y}}}^{( f )} = {\underline{\underline{y}}}^{( e )} \cdot {\underline{\underline{T}}}^{( ef )} ⇔ {y}_{J {α}^{( f )}}^{( f )} = {\sum }_{{α}^{( e )} = {1}^{( e )}}^{{N}_{c}^{( e )}} {y}_{J {α}^{( e )}}^{( e )} {T}_{{α}^{( e )} {α}^{( f )}}^{( ef )} \qquad ( 32 )$$

Such an operation is performed in block 108.

Because all the elements

$${T}_{{α}^{( e )} {α}^{( f )}}^{( ef )} and {y}_{J {α}^{( e )}}^{( e )}$$

are numbers between 0 and 1, bounds included, as described by equations (25) and (28), the elements

$${y}_{J {α}^{( f )}}^{( f )}$$

are also numbers between 0 and 1, bounds included. Also, the sum of all the elements of any column of the y^{(f)} matrix is equal to 1 as can be proven using equation (27):

$$\begin{matrix}{\sum }_{J = 1}^{{N}_{P}} {y}_{J {α}^{( f )}}^{( f )} = {\sum }_{{α}^{( e )} = {1}^{( e )}}^{{N}_{c}^{( e )}} ( {\sum }_{J = 1}^{{N}_{P}} {y}_{J {α}^{( e )}}^{( e )} ) {T}_{{α}^{( e )} {α}^{( f )}}^{( ef )} = {\sum }_{{α}^{( e )} = {1}^{( e )}}^{{N}_{c}^{( e )}} {T}_{{α}^{( e )} {α}^{( f )}}^{( ef )} = 1 , \\ ∀ J ∈ [ 1 , {N}_{P} ] \end{matrix} \qquad ( 33 )$$

The matrix y^{(f)} defined by equation (32) has then all the required properties and can be used to relate the phase and component molar densities in the kerogen domain as:

η^{(f)}=y^{(f)}·m^{(f)} (34)

In block 110, the elements

$${x}_{{α}^{( f )} J}^{( f )}$$

of the non-square N_{c}^{(f)}×N_{P} composition matrix x^{(f)} are calculated using equation (9), that is,

$${x}_{{α}^{( f )} J}^{( f )} = {y}_{J {α}^{( f )}}^{( f )} {m}_{{α}^{( f )}}^{( f )} / {η}_{J} .$$

.By construction, each of these elements are numbers between 0 and 1, bounds included, as required for mole fractions. Also, the sum over the elements of any column of the x^{(f)} matrix is equal to 1. By construction, the matrix x^{(f)} also relates the mixture molar densities of the phases and the components as described by equation (5), that is,

m^{(f)}=x^{(f)}·η^{(f)} (35)

The method ensures that mass is balanced because of the properties of the constructed y^{(f)} and x^{(f)} matrices whose elements exhibit the properties described in equations (6) and (3), respectively.

At block 112, the derivatives of the phase properties with respect to the to mixture molar densities of the flowing components

$$( {m}_{{α}^{( f )}}^{( f )} )$$

needed for the iterative resolution of the system of equations that includes equations of the type of equation (23), are easily evaluated using the chain rule, which is known to those skilled in the art. For example, considering the intrinsic phase molar densities ξ_{J}, for any phase J and any flowing component α^{(f)}:

$$\frac{\partial {ξ}_{J}}{\partial {m}_{{α}^{( f )}}^{( f )}} = {\sum }_{{α}^{( e )} = {1}^{( e )}}^{{N}_{c}^{( e )}} \frac{\partial {ξ}_{J}}{\partial {m}_{{α}^{( e )}}^{( e )}} \frac{\partial {m}_{{α}^{( e )}}^{( e )}}{\partial {m}_{{α}^{( f )}}^{( f )}} = {\sum }_{{α}^{( e )} = {1}^{( e )}}^{{N}_{c}^{( e )}} \frac{\partial {ξ}_{J}}{\partial {m}_{{α}^{( e )}}^{( e )}} {T}_{{α}^{( e )} {α}^{( f )}}^{( ef )} , \qquad ( 36 )$$

where the derivatives with respect to the mixture molar densities of the EOS components, that is,

$$\partial {ξ}_{J} / \partial {m}_{{α}^{( e )}}^{( e )} ,$$

are provided by the phase equilibrium calculations. The fluid flow equations can then be solved.

From the foregoing teaching of this invention, one skilled in the art may be inclined to peform flow calculations in the EOS domain with the inverse transformation replaced by the use of the generalized inverse, T^{*(fe)}, of the transformation matrix T^{(ef)}, applied to the vector of the EOS components mixture molar densities ⁿm^{(e)} obtained after the compositional miscible fluid flow has been performed:

ⁿm^{(f)}=T^{x(fe)}·ⁿm^{(e)}=[T^{(ef)}^{^{T}}·T^{(ef)}^{⁻¹}]·T^{(ef)}^{^{T}}·ⁿm^{(e)} (37)

However, because an EOS component can be present in several flowing components, this operation may not ensure that all the elements of the new vector of the mixture molar densities of the flowing components would be non-negative as required by the physics. This situation will be illustrated in the following simplified example.

### Example Calculation

The following simplified example is provided to illustrate one aspect of the present invention. Only four flowing components are considered: dry gas, wet gas, oil and water (i.e., N_{c}^{(f)}=4). The normalized vector of the mixture molar densities of the flowing components m^{(f)} is m^{(f)=(}0.10, 0.50, 0.20, 0.20)^{T}, respectively for the dry gas, the wet gas, the oil and the water. The dry gas is simply methane (C₁). The wet gas is assumed to be composed of methane, propane (C₃) and n-butane (C₄). The oil is assumed to be simply a combination of the paraffins nC₁₀ and nC₁₆. The water component is common to both domains. The number of EOS components is then N_{c}^{(e)}=6 so that the transformation matrix T^{(ef)} is 6×4, chosen to be:

$${{T}_{{-}_{-}}}^{( ef )} = ( \begin{matrix}1 & 0.8510 & 0 & 0 \\ 0 & 0.1190 & 0 & 0 \\ 0 & 0.0300 & 0 & 0 \\ 0 & 0 & 0.4440 & 0 \\ 0 & 0 & 0.5560 & 0 \\ 0 & 0 & 0 & 1\end{matrix} )$$

It is easy to verify that the elements of the above matrix verify the required properties listed in equations (25) and (27). Application of equation (24) gives the normalized vector of the mixture EOS component molar densities:

$$\begin{matrix} & {C}_{1} & {C}_{3} & n {C}_{4} & n {C}_{10} & n {C}_{16} & {H}_{2} O \\ {\underline{m}}^{( e )} = {\underline{\underline{T}}}^{( ef )} \cdot {\underline{m}}^{( f )} = & ( 0.52550 & 0.05950 & 0.0150 & 0.00880 & 0.1120 & { 0.20 )}^{T}\end{matrix}$$

As required by equation, mass balance is preserved as:

$${\sum }_{{α}^{( f )} = {1}^{( f )}}^{{N}_{c}^{( f )}} {m}_{{α}^{( f )}}^{( f )} = {\sum }_{{α}^{( e )} = {1}^{( e )}}^{{N}_{c}^{( e )}} {m}_{{α}^{( e )}}^{( e )} = 1.$$

Phase equilibrium is performed using the Peng-Robinson equation of state for the petroleum components at a pressure of 3000 psia (20,685 kPa) and a temperature of 212° F. (100° C.) The solubility of the petroleum components in the aqueous phase is governed by Henry's law. The calculations are performed in double precision and are given with the scientific notations ZE+xx or E−xx that implies that the number Z has to be multiplied by 10 to the power +xx or −xx. For reason of presentation, not all the digits will be given thereafter. However, errors, if any, with respect to the expected properties are given.

The equilibrium corresponds to the presence of three phases: aqueous, liquid and vapor with a normalized mixture phase molar density η^{(e)} equal to

$$\begin{matrix}Aqueous & Liquid & Vapor \\ {\underline{η}}^{( e )} = ( 19.411312951 E \text{-} 02 & 51.467908926 E \text{-} 02 & {29.120778123 E \text{-} 02 )}^{T}\end{matrix}$$

and a non-square 6×3 composition matrix x^{(e)} which is given in Table 1. The sum over the elements for each of the the three columns is equal to 1 with no error.

The non-square 3×6 matrix y^{(e)} whose elements, calculated using equation (10), represent the distribution of the EOS components among the phases are given in Table 2.

For a given component, the sum of the elements over all three phases is equal to 1 with an error that never exceed 5×10⁻¹⁴% (see Table 3).

The elements of the non-square matrix 3×4 y^{(f)}, calculated using equation (32), are given in Table 4. All the elements are non-negative and less than 1. As shown in Table 5, for any flowing component, the error with respect to 1 of the sum of the elements over the phases is less than 44×10⁻¹⁴%, i.e., it is zero. Comparing Table 5 and Table 3, one may notice that the errors are the same for the dry gas and the water in both domains, as expected.

The elements of the non-square 4×3 matrix x^{(f)}, computed using equation (9), are listed in Table 6. All the numbers are non-negative and less than 1. The relative error compared to 1 of the sum of the elements over the components for each phase is −11.102230246E-17% for the aqueous phase and zero for both the liquid and vapor phases.

Another check can be made by considering the matrix product C^{(f)}=y^{(f)}·x^{(f)} (equation (12)) and its inverse, C^{(f)}^{⁻¹}. The elements of the 3×3 matrix C are given in Table 8.

The sum over the elements of each column is equal to 1 with a relative error of (44.098058538E-14, 13.988810110E-14, 46.629367034E-15) % from the left to the right, i.e., it is negligible. Using the vector of the mixture phase velocity, the product C^{(f)}·η^{(e)} yields, as expected, the vector η^{(e)} with a relative error for the aqueous phase of 44.054170209E-14% for the aqueous phase, −13.611408413E-14% for the liquid phase and −53.184056854E-14% for the vapor phase. These errors are negligible.

Table 8 gives the elements of the 3×3 inverse matrix C^{(f)}^{⁻¹}. As expected, the sum over the elements of each column is equal to 1, with again negligible relative errors of −45.996539910E-14% for the first column, 28.19966492E-14% for the second column and −19.140244945E-14% for the third one.

For illustration of the usefulness of the present invention, Table 9 gives the elements of the generalized inverse of the composition matrix as indicated by equation (11). The mole fraction of the dry gas in the liquid phase is negative, and, as such, is physically unacceptable. Despite this problem, it is interesting to note that the sum over the phases for each of the flowing components is equal to 1 within the precision of the calculations.

Another way that could be argued to be considered is based on the transformation equation (24) . Using the definition of the generalized inverse (see equation (11) in the case of the x matrix), one obtains:

m^{(f)}=T^{(ef)*}·m^{(e)}

where T^{(ef)x} is the generalized inverse of the non-square matrix T^{(ef)}. Its elements are given in Table 9. Using the relation (5) in both domains along with the fact that the phases are identical in both domains, identification of the coefficients of the elements of the mixture phase molar density η yields:

x^{(f)*}=T^{(ef)*}·x^{(e)}

The elements of the non-square 4×3 matrix x^{(f)*} are given in Table 10. Compared to Table 6, the mole fraction of the dry gas in the liquid phase is negative. This example shows that this procedure is only approximate. The problem for the dry gas is related to the fact that it is present in two of the flowing components.

TABLE 1
Elements of the matrix x^{(e)}.

| | | |
|---|---|---|
| Phase; | ${\underline{\underline{x}}}^{( e )} = \begin{matrix} \begin{matrix}Aqueous & Liquid & Vapor\end{matrix} \\ ( \begin{matrix}20.076217492 E \text{-} 04 & 50.137287505 E \text{-02} & 91.709142667 \text{E-} 02 \\ 31.866635888 E \text{-} 06 & 83.865614398 E \text{-} 03 & 56.076579273 E \text{-} 03 \\ 34.964175851 E \text{-} 07 & 23.380789111 E \text{-} 03 & 10.184199203 E \text{-} 03 \\ 55.401357854 E \text{-} 25 & 16.828493565 E \text{-} 02 & 75.110032192 E \text{-} 04 \\ 14.526420358 E \text{-} 26 & 21.528886336 E \text{-} 02 & 13.575319879 E \text{-} 04 \\ 99.795701520 E \text{-} 02 & 78.069224239 E \text{-} 04 & 77.792596434 E \text{-} 04\end{matrix} )\end{matrix}$ | $\begin{matrix}Component \\ {\text{C}}_{1} \\ {\text{C}}_{3} \\ {\text{nC}}_{4} \\ {\text{nC}}_{10} \\ {\text{nC}}_{16} \\ {\text{H}}_{2} \text{O}\end{matrix}$ |

TABLE 2
Elements of the y^{(e)} matrix.

$\begin{matrix}\begin{matrix} {C}_{1} & & {C}_{3} & & {nC}_{4} & & {nC}_{10} & & {nC}_{16} & & {H}_{2} O \end{matrix} \\ ( \begin{matrix}74.159037225 E \text{-} 05 & 10.396188940 E \text{-} 05 & 45.246703968 E \text{-} 06 & 0 & 0 & 96.858279668 E \text{-} 02 \\ 49.104878156 E \text{-} 02 & 72.544332837 E \text{-} 02 & 80.224021639 E \text{-} 02 & 97.536866461 E \text{-} 02 & 99.644492915 E \text{-} 02 & 20.090298615 E \text{-} 03 \\ 50.820962807 E \text{-} 02 & 27.445270974 E \text{-} 02 & 19.771453691 E \text{-} 02 & 24.631335386 E \text{-} 03 & 35.550708466 E \text{-} 04 & 11.326904702 E \text{-} 03\end{matrix} ) \begin{matrix}Aqueous \\ Liquid \\ Vapor\end{matrix}\end{matrix}$

TABLE 3
$List of errors on {\sum }_{J = 1}^{3} {y}_{{α}^{( e )} J}^{( e )} \text{from Table 2.}$

| $Error on {\sum }_{J = 1}^{3} {y}_{{α}^{( e )} J}^{( e )} ( \% )$ | Component |
|---|---|
| −40.745185004E-15 | C₁ |
| −15.187850977E-14 | C₃ |
| −18.807178037E-14 | nC₄ |
| −27.045032880E-14 | nC₁₀ |
| −28.033131372E-14 | nC₁₆ |
| 44.164671920E-14 | H₂O |

TABLE 4
Elements of the y^{(f)} matrix.

${\underline{\underline{y}}}^{( f )} = \begin{matrix}\begin{matrix} Dry {gas}_{} & Wet gas & {Oil}_{} & Water & \end{matrix} & \\ ( \begin{matrix}74.159037225 E \text{-} 05 & 64.482227274 E \text{-} 05 & 0 & 96.858279668 E \text{-} 02 \\ 49.104878156 E \text{-} 02 & 52.827747568 E \text{-} 02 & 98.708706770 E \text{-} 02 & 20.090298615 E \text{-} 03 \\ 50.820962807 E \text{-} 02 & 47.107770205 E \text{-} 02 & 12.912932302 E \text{-} 02 & 11.326904702 E \text{-} 03\end{matrix} ) & \begin{matrix}\begin{matrix}\text{Aqueous} \\ \text{Liquid}\end{matrix} \\ \text{Vapor}\end{matrix}\end{matrix}$

TABLE 5
$List of errors on {\sum }_{J = 1}^{3} {y}_{{α}^{( i )} J}^{( f )} from TABLE 2.$

| $Error on {\sum }_{J = 1}^{3} {y}_{{α}^{( i )} J}^{( f )}$ | Component |
|---|---|
| −40.745185004E-15 | Dry gas |
| −58.397731095E-15 | Wet gas |
| −27.589042162E-14 | Oil |
| −44.164671920E-14 | H₂O |

TABLE 6
Elements of the x^{(f)} matrix
${\underline{\underline{x}}}^{( f )} = \begin{matrix} \begin{matrix}Aqueous & Liquid & Vapor\end{matrix} \\ ( \begin{matrix}38.204029481 E \text{-} 05 & 95.408729791 E \text{-03} & 17.451787377 \text{E-} 02 \\ 16.609445079 E \text{-} 06 & 51.321054877 E \text{-} 02 & 80.883433138 E \text{-} 02 \\ 00.000000000 E \text{+} 00 & 38.357379901 E \text{-} 02 & 88.685352071 E \text{-} 04 \\ 99.795701520 E \text{-} 02 & 78.069224239 E \text{-} 04 & 77.792596434 E \text{-} 04\end{matrix} ) \end{matrix} \begin{matrix} \\ \text{Dry Gas} \\ \text{Wet Gas} \\ \text{Oil} \\ {\text{H}}_{2} \text{O}\end{matrix}$

TABLE 7
Elements of the C^{(f)} = y^{(f)} · x^{(f)} matrix.
${\underline{\underline{C}}}^{( f )} = ( \begin{matrix}96.660548905 E \text{-} 02 & 79.432407833 E \text{-04} & 82.212538626 \text{E-} 04 \\ 21.061017059 E \text{-} 03 & 70.461549173 E \text{-} 02 & 50.802217283 E \text{-} 02 \\ 12.333493887 E \text{-} 03 & 28.744126749 E \text{-} 02 & 48.375657331 E \text{-} 02\end{matrix} )$

TABLE 8
Elements of the C^{(f)}_{₋₁}matrix, inverse of the C^{(f)} matrix.
${\underline{\underline{C}}}^{{( f )}^{- 1}} = ( \begin{matrix}10.348385515 E \text{-} 01 & - 78.579476014 E \text{-04} & - 93.345684044 \text{E-} 04 \\ - 20.834867405 E \text{-} 03 & 24.830513807 E \text{-} 01 & - 26.072490556 E \text{-} 01 \\ - 14.003684144 E \text{-} 03 & - 14.751934331 E \text{-} 01 & 36.165836240 E \text{-} 01\end{matrix} )$

TABLE 9
Elements of the matrix T^{(ef)*}, generalized inverse
of the matrix T^{(ef)}(T^{(ef)*} = ([T^{(ef)}]^{T} · T^{(ef)})⁻¹ · T^{(ef)}]^{T}).
$( \begin{matrix}1 & - 67.2392 E \text{-} 01 & - 16.9511 E \text{-} 01 & 0 & 0 & 0 \\ 0 & 79.0120 E \text{-} 01 & 19.9190 E \text{-} 01 & 0 & 0 & 0 \\ 0 & 0 & 0 & 87.6999 E \text{-} 02 & 10.9822 E \text{-} 01 & 0 \\ 0 & 0 & 0 & 0 & 0 & 1\end{matrix} )$

TABLE 10
Elements of the x^{(f)*} matrix. Compare with Table 6.
${\underline{\underline{x}}}^{( f ) *} = \begin{matrix} \begin{matrix}Aqueous & Liquid & Vapor\end{matrix} \\ ( \begin{matrix}17.874261519 E \text{-} 04 & - 10.216596370 E \text{-02} & 52.277353861 \text{E-} 02 \\ 25.874923300 E \text{-} 05 & 70.921132638 E \text{-} 02 & 46.335827034 E \text{-} 02 \\ 00.000000000 E \text{+} 00 & 38.402107851 E \text{-} 02 & 80.780157990 E \text{-} 04 \\ 99.795701520 E \text{-} 02 & 78.069224239 E \text{-} 04 & 77.792596434 E \text{-} 04\end{matrix} )\end{matrix} \begin{matrix} \\ \text{Dry Gas} \\ \text{Wet Gas} \\ \text{Oil} \\ {\text{H}}_{2} \text{O}\end{matrix}$

While much of the foregoing description is directed toward oil field basin and reservoir simulation, it is understood that the disclosed method will also apply to models and simulations in a wide variety of sciences. A person skilled in the art, particularly one having the benefit of the teachings of this patent, will recognize many modifications and variations to the specific embodiments disclosed above. As discussed above, the specifically disclosed embodiments and examples should not be used to limit or restrict the scope of the invention, which is to be determined by the claims below and their equivalents.

### Appendix

Superscripts

^{(e)}: indicates that the variable belongs to the EOS (Equation of State) domain.

^{(f)}: indicates that the variable belongs to the flowing components domain.

When no superscript is present, the relation is valid in any domain.

*: indicates that the matrix is a generalized inverse.

^{T}: indicates the transpose of a matrix.

⁻¹: indicates the inverse of a matrix.

Subscripts

A lower case Greek letter (_{α} for example) indicates a component.

An upper case Latin letter (_{J} for example) indicates a fluid phase.

Mathematical Symbols

∀ means “for all”.

⊂ means ‘belongs to’.

[1, N] means ‘interval 1 to N, bounds included’.

A vector is indicated by an underlined letter (m for example).

A matrix is indicated by a double underlined letter (x for example).

$${\sum }_{α = 1}^{{N}_{c}} X$$

means sum of expression X from α=1 to N_{c}.

The Einstein convention is not used (i.e., no sum over repeated indices). div indicates the divergence operator (with respect to Eulerian coordinates). grad indicates the gradient operator (with respect to Eulerian coordinates). A matrix product is indicated by the symbol ‘·’.

Greek Letters

δ_{IJ}: indicates the Kronecker symbol (=0 for I≠J, =1 for I=J).

η: N_{P} vector of the mixture molar densities of the phases.

η_{J}: mixture molar density of fluid phase J.

μ_{J}: viscosity of fluid phase J.

ξ_{J}: intrinsic molar density of fluid phase J.

ρ_{J}: intrinsic mass density of fluid phase J.

φ: porosity of material.

Latin Letters

c*: N_{c}×N_{c} matrix equal to the product x·y*.

c: N_{c}×N_{c} matrix equal to the product x·y.

C*: N_{P}×N_{P} matrix equal to the product y*·x.

C: N_{P}×N_{P} matrix equal to the product y·x.

d_{αJ}: mixture molar density of component α in fluid phase J.

g: acceleration of gravity.

I^{N}^{_{P}}: N_{P}×N_{P} identity matrix.

kr_{J}: relative permeability of fluid phase J.

K: absolute permeability of a material.

m: total mixture molar density of a system.

m: N_{c} vector of the mixture molar density of the components.

m_{α}: mixture molar density of component α.

N_{c}: number of components.

N_{P}: number of phases.

P: reference pressure.

P_{cJ}: capillary pressure of fluid phase J.

$${q}_{{α}^{( f )}}^{( f )}$$

source mixture molar density rate for component α^{(f)}.

S_{J}: saturation of fluid phase J.

v^{(α}^{^{(f)}}⁾: N_{c}^{(f)} vector whose elements are the particle velocities of the components α^{(f)}.

V^{(J)}: vector of the particle velocity of fluid phase J.

V^{(R)}: vector of the particle velocity of the solid phase.

t: time.

T^{(ef)}: N_{c}^{(e)}×N_{c}^{(f)} matrix of the mapping from the flowing components domain to the EOS components domain.

x_{αJ}: mole fraction of component α in fluid phase J. (composition of the phase).

x: N_{c}×N_{P} matrix whose elements are the x_{αJ}. Each column gives the composition of a phase.

y_{Jα}: fluid phase (J) mole fraction of component α.

y: N_{P}×N_{c} matrix whose elements are the y_{Jα}. Each column gives the distribution of a component among the phases.

z: depth (Eulerian coordinate).

What is claimed is:

1. A method of estimating one or more properties of a multi-component fluid contained in a physical system containing two or more phases, comprising the steps of:
(a) equating the physical system in at least one dimension to a multiplicity of cells;
(b) for each cell, characterizing the multi-component fluid in the cell using a property of a first set of components and representing the characterization by a first vector;
(c) converting the first vector to a second vector using a transformation matrix, the transformatin matrix being indicative of the distribution of the first set of components and the second vector being representative of a property of a second set of components greater in number than the first set of components;
(d) using the second vector to determine the number and properties of phases present in each cell;
(e) determining the elements of a first matrix that expresses distribution of the second vectors among the phases;
(f) determining the elements of a second matrix that expresses how the first vectors are distributed among the phases using the transformation matrix and the first matrix;
(g) determining a third matrix that expresses the composition of the phases in terms of the first vectors; and
(h) using the third matrix to perform fluid flow calculations to estimate one or more properties of the multi-component fluid.

2. A method for simulating fluid movement and phase change behavior, wherein the method comprises:
(a) determining for each of a plurality of discrete cells a vector of first domain component concentrations;
(b) transforming the first domain component vectors into vectors of second domain component concentrations;
(c) applying to the second domain component vectors, equations of state to determine second domain component distribution matrices indicative of a distribution of the second domain components among each of the phases;
(d) converting the second domain component distribution matrices to first domain component distribution matrices; and
(e) applying the first domain component distribution matrices to fluid flow equations to determine for each of the plurality of discrete cells an updated vector of first domain component concentrations.

3. The method of claim 2, wherein the converting includes multiplying the second domain component distribution matrix with a transform matrix.

4. The method of claim 2, further comprising:
displaying the concentrations of a desired component in a given cell at a given time.

5. A nonlinear process simulator which comprises:
(a) a display monitor;
(b) a processor coupled to the display monitor and configured to display time evolution of the process; and
(c) a memory configured to store software for access by the processor, wherein the software includes:
a second domain module which configures the processor to determine a distribution of second domain components among a plurality of phases, wherein the second domain component distribution is expressible in terms of a second domain component distribution matrix having elements that specify what fraction of each second domain component is found in a given phase; and
a conversion module which configures the processor to convert the second domain component distribution matrix into a first domain component distribution matrix by multiplying the second domain component distribution matrix with a transform matrix to obtain a first domain component distribution matrix, wherein the second domain components are expressible as a product of the first domain components and the transform matrix.

6. The simulator of claim 5 wherein the software further includes:
(a) a first domain module which configures the processor to determine for each of a plurality of discrete cells a vector of first domain component concentrations;
(b) a transform module which configures the processor to transform the first domain component concentration vectors into second domain component concentration vectors, wherein the second domain module operates on the second domain component concentration vectors to determine the second domain component distribution matrix.

7. The simulator of claim 6 wherein the software further includes a display module that configures the processor to display concentrations of a desired component in a given cell at a given time.

8. The simulator of claim 6, wherein the first domain module performs simulation of fluid flow, and the second domain module performs simulation of fluid phase behavior.

9. The simulator of claim 8, wherein the software configures the processor to simulate development of petroleum reservoirs by repetition of actions that include simulating fluid flow in the first domain, transforming first domain component concentrations into second domain component concentrations, simulating fluid phase behavior in the second domain, and converting the second domain component distribution matrix into the first domain component distribution matrix.

10. The simulator of claim 8, wherein the software configures the processor to simulate movement of petroleum in petroleum reservoirs by repetition of actions that include simulating fluid flow in the first domain, transforming first domain component concentrations into second domain component concentrations, simulating phase behavior in the second domain, and converting the second domain component distribution matrix into the first domain component distribution matrix.

11. An information carrier medium configured to provide a processor with a program, wherein when the processor executes the program the processor is configured to:
(a) determine a distribution of second domain components among a plurality of phases, wherein the distribution is expressible as a second domain component distribution matrix having elements that specify what fraction of each second domain component has a given phase; and
(b) convert the distribution of second domain components among the phases to a distribution of first domain components among the phases, wherein the second domain components are expressible as a product of the first domain components and a transform matrix, and wherein the conversion of the distribution includes multiplying the second domain component distribution matrix with the transform matrix to obtain a first domain component distribution matrix.

12. The carrier medium of claim 11, wherein the carrier medium is a computer-readable information storage medium.

13. The carrier medium of claim 11, wherein the carrier medium is an information transmission medium.

14. The carrier medium of claim 11, wherein the program further configures the processor to:
(a) evaluate equations expressed in terms of a first domain to determine first domain component values;
(b) transform the first domain component values into second domain component values; and
(c) evaluate equations expressed in terms of a second domain to determine the distribution of second domain components.

15. The carrier medium of claim 14, wherein the first domain equations include fluid flow continuity equations, and wherein the second domain equations include phase equilibrium and flash equations.

16. The carrier medium of claim 15, wherein the program configures the processor to simulate development of petroleum reservoirs by repetition of actions that include evaluating fluid flow equations in the first domain, transforming first domain component values into second domain component values, evaluating phase equilibrium and flash equations in the second domain, and converting the second domain component distribution into the first domain component distribution.

17. The carrier medium of claim 15, wherein the program configures the processor to simulate movement of petroleum in petroleum reservoirs by repetition of actions that include evaluating fluid flow equations in the first domain, transforming first domain component values into second domain component values, evaluating phase equilibrium and flash equations in the second domain, and converting the second domain component distribution into the first domain component distribution.
